(19) United States
(12) Patent Application Publication
(10) Pub. No.: US 2024/0229888 A1
(43) Pub. Date: Jul. 11, 2024

(54) AIR SPRING

(71) Applicant: CARBON AIR LIMITED, Manchester (GB)

(72) Inventors: James Massaglia, Manchester (GB); John Fitzgerald COAKLEY, Manchester (GB)

(73) Assignee: CARBON AIR LIMITED, Manchester, EN (GB)

(21) Appl. No.: 18/261,755

(22) PCT Filed: Jan. 18, 2022
(86) PCT No.: PCT/GB2022/050136

§ 371 Date: Jul. 17, 2023

(30) Foreign Application Priority Data
Jan. 18, 2021 (GB) 2100634.1
Dec. 2, 2021 (GB) 2117442.0

(51) Int. Cl. F16F 9/02

(52) U.S. Cl. CPC F16F 9/0218; F16F 2224/0225; F16F 2228/063

(57) ABSTRACT

There is provided an air spring for supporting a load comprising a main chamber containing a positively pressurised gas in use, a spacing element having a variable volume and being within the main chamber, and a load-bearing surface arranged to transmit a force from a load in use to the positively pressurised gas. There is also provided an air spring for supporting a load comprising a main chamber containing a positively pressurised gas in use, a spacing element having a fixed volume that occupies a volume of the main chamber, and a load-bearing surface arranged to transmit a force from a load in use to the positively pressurised gas.

### CROSS-REFERENCE TO RELATED APPLICATIONS

This application is a national-stage of PCT/GB2022/050136, filed Jan. 18, 2022, which claims priority to GB 2100634.1, filed Jan. 18, 2021, and GB 2117442.0, filed Dec. 2, 2021.

### FIELD OF THE INVENTION

This invention relates to vehicle suspension systems and devices, and particularly to vehicle suspension systems and devices having an air spring with adjustable and/or tuneable characteristics that help deliver the benefits of adsorptive materials inside the cavity while overcoming their main limitations.

### BACKGROUND OF THE INVENTION

Air springs are widely used in vehicle suspension including bicycles and motorcycles and can come in many forms, but all operate on the same principle. A column of gas—usually air but often nitrogen—is confined within a chamber which can be compressed along one or more axis. The gas pressure within the chamber determines the force that the spring exerts, and the rate of change of pressure with excursion determines the rate of change of force exerted. This defines the “spring rate”, or stiffness of the spring. The confinement may take the form of a reinforced rubber bellows, but in the case of bike suspension, it usually takes the form of a cylindrical chamber surrounded by a second telescopic housing which bears on the gas via a piston surrounded by a lubricated, air-tight dynamic seal.

Standard air springs are lighter than coil springs and are infinitely tuneable to account for loading, but they can have less desirable operating characteristics. The spring rate or stiffness of a coil spring is perfectly linear, while the stiffness of an air spring can be firm at the beginning of travel, and very firm indeed toward the end of travel. The air chamber of an air spring is pressurized and at the start of compression, the load is pushing against the fully pressurized air spring. This is in comparison to a coil spring, where there is very little initial resistance unless the spring has been significantly preloaded. Efforts have been made to increase the initial suppleness of air spring suspension by adding a negative spring which can be either an air or coil spring. The negative spring in a motorcycle/bicycle fork, for example, puts pressure on the air piston from the opposite or rear side of it to cancel out the positive air pressure during the initial compression and travel of the fork. At rest, a fork with equal pressure in the positive and negative chamber should theoretically feel like a coil and need very little loading pressure to initiate fork travel. As the fork starts to compress, the negative chamber, which is typically very small in volume compared to the positive chamber, begins to expand, quickly reducing the counteracting force it can apply. For maximum softness around the start of compression, the largest possible negative air spring chamber should be used, to maintain near-equilibrium as the piston progresses. A very small negative air spring will see its compensating force die away very quickly. However, a consequence of a larger negative air spring is that the fork- or shock- as a whole will reach an equilibrium position under load-called the “sag” point- deeper into the suspension travel, which will upset the geometry of the entire bike.

To compensate against this, a proportion of the main chamber volume may be occupied by volume spacers, representing a blanking volume within the chamber. This causes force to build up quickly enough to achieve the same sag point—where the static pressure in the spring is equal to the pressure on the piston caused by the weight of the bike and rider-despite the use of an enlarged negative chamber. The consequence of this is a greater ramp-up force beyond the equilibrium point, shortening the useful compression travel of the device before pressure in the positive chamber becomes overwhelming.

One means of addressing this issue is the inclusion of a compressible blanking volume- or adjustable air chamber—in addition to the positive and negative air springs, as described in US patent application 2016/0001847 A1. The adjustable air chamber may generally occupy a space at the top of the stanchion (at the crown) and above the positive air spring. The adjustable air chamber may generally include a tubular portion with one end connected to a valve to pressurize the chamber, and the other end being open to the positive air spring below. The adjustable air chamber further includes a floating piston within the tubular portion which may generally translate vertically within the tubular portion between the two ends. The tubular portion may generally include a retaining stop for retaining the floating piston within the tubular portion and thus preventing the floating piston from translating out through the lower end of the tubular portion into, for example, the positive air spring. The adjustable air chamber may thus be utilized by pressurizing the space between the valve end and the floating piston with gas such that the floating piston translates downward to restrict the volume of the positive air spring. During use, load on the fork may then load both the positive air spring and the adjustable air chamber, with the adjustable air chamber decreasing in volume during at least part of the travel due to the increased pressure in the positive air spring pushing on the floating piston. In some embodiments. the adjustable air chamber may also include at least one spacer between the floating piston and the retaining stop of the tubular portion, such that the maximum volume of the adjustable air chamber between the floating piston and the valve end may be adjusted. This may generally be desirable to tune the characteristics of the adjustable air chamber and its interaction with the positive air spring.

Such an additional high pressure chamber housed within the positive chamber causes the positive spring to behave as if it had a restricted length with a higher sag point, but with a more aggressive force build up until the point where the pressures are equalised, whereafter the full chamber is in use, causing force build up to be reduced significantly toward the end of travel.

The aim of the present invention is to realise the benefits of retaining the higher sag position with a larger negative chamber, but without the penalty of the aggressive force build up before the pressures are equalised—in effect to make the restricted chamber behave like a full chamber that doesn't contain an additional chamber, before the additional chamber comes into play.

### SUMMARY OF THE INVENTION

A vehicle suspension device according to the present invention comprises an air spring with a main chamber which contains positively pressurised gas and a blanked-off volume to maintain a desired sag point under load, wherein the main chamber further comprises a gas-adsorbent material, the quantity of which is tuned to compensate for the increase in dynamic stiffness caused by the presence of the blanked-off volume.

The benefit of said arrangement is that the adsorbent material will cause a reduction in dynamic spring rate- or stiffness- while maintaining the same static pressure under load at the desired sag point.

The adsorptive material may be activated carbon, in granular or agglomerated monolith form, housed within a cartridge with a filtered and perforated end-cap.

A second embodiment comprises an air spring with a main chamber which contains positively pressurised gas which main chamber is in fluid communication with a secondary variable volume chamber, and wherein the main chamber further comprises a gas-adsorbent material, the quantity of which is tuned to compensate, in part or in full, for the loss of volume in the main chamber caused by the presence of the secondary variable volume chamber.

The use of both the adsorptive material and the variable secondary volume results in a more linear build-up in stiffness throughout an increased useable travel than would be possible by using either technology on its own.

The secondary variable volume may be achieved by deploying a floating piston at the top of the primary chamber which is restricted in its downward movement by a lip, protrusion, series of protrusions or a change in bore in the main chamber, wherein the pressure above the floating piston is set to be greater than that in the primary chamber at or around equilibrium under load.

Said floating piston may feature a quantity of adsorptive material within it, in fluid communication with the primary chamber but not the secondary chamber.

Said floating piston may feature a secondary quantity of adsorptive material within it in fluid communication with the secondary chamber, wherein the two portions of adsorptive material are separated by an impermeable dividing wall which serves to maintain the air-tight impermeability of the floating piston.

The secondary variable volume, including the adsorptive material in fluid communication with the primary chamber, may be housed entirely within its own removeable cartridge mounted to the underside of the air cap in the crown of the bike fork.

Said air cap may feature two valves—one in fluid communication with the volume above the floating piston and used to set the pressure in the variable volume second chamber, the other in fluid communication with the main air spring chamber and used for setting the pressure in the main air spring to achieve the desired sag point,

The secondary variable volume, including the adsorptive material in fluid communication with the primary chamber, may be housed outside the main chamber in a secondary chamber, which is kept in fluid communication with the primary chamber via a fixed link or flexible tube.

The quantity of gas-adsorbent material may also be tuned to cause a dynamic rate in the main chamber that is lower than the dynamic rate of both the main chamber and the secondary variable volume chambers combined.

In one aspect, the present invention provides an air spring for supporting a load, the air spring comprising: a main chamber containing a positively pressurised gas in use; a spacing element having a variable volume and being within the main chamber; a load-bearing surface arranged to transmit a force from a load in use to the positively pressurised gas; and optionally, a negative spring device arranged to transmit a force to the load-bearing surface.

Preferably, the air spring contains a mass of adsorptive material to lower the (dynamic) spring rate. Alternatively, or additionally, the air spring contains a mass of heat sink material (such as open-cell foam (i.e. a material having a cellular structure) and/or a block of gas permeable resilient material), and/or a mass of absorptive material. Such materials may be present in any one or more of the main chamber; the optional spacing element having a variable volume; and the optional negative spring device.

Preferably, the adsorptive material is activated carbon.

In one embodiment, the variable volume of the spacing element is compressed at a predetermined pressure in use by the positively pressurised gas in the main chamber. Providing a variable volume of gas being compressed in the air spring and thus a variable spring rate.

In one embodiment, the spacing element comprises a movable member. Preferably, the variable volume is separated from the main chamber by the moveable member. In one embodiment the spacing element is a removable unit (e.g. a cartridge) from the air spring. Preferably the variable volume is sealed relative to the remainder of the main chamber.

In one embodiment, the main chamber contains a mass of adsorptive material and/or open-cell foam to lower the spring rate. Alternatively, or additionally, the variable volume contains a mass of adsorptive material and/or open cell foam to lower the spring rate.

In one embodiment, the main chamber and the variable volume contain a mass of adsorptive material and/or open cell foam to lower the spring rate.

In one embodiment, the negative spring device comprises a chamber and a positively pressured gas within the chamber. Preferably, the chamber contains a mass of adsorptive material and/or open cell foam. In one embodiment, the negative spring device is a removable unit from the air spring.

In one embodiment, the air spring further comprises a spacing element having a fixed volume that occupies a volume of the main chamber.

Preferably the variable volume of the movable member comprises a sealed secondary cavity, within the main chamber, containing in use a pressurised gas P2.

In one aspect, the present invention provides a suspension fork comprising an air spring as disclosed herein.

In one aspect, the present invention provides a bicycle or motorbike comprising an air spring as disclosed herein. Preferably, the bicycle is a mountain bike.

In one aspect, the present invention provides a bicycle or motorbike comprising a suspension fork as disclosed herein. Preferably, the bicycle is a mountain bike.

In one aspect, the present invention provides an air spring for supporting a load, the air spring comprising: a main chamber containing a positively pressurised gas in use; a spacing element having a fixed volume that occupies a volume of the main chamber; a load-bearing surface arranged to transmit a force from a load in use to the positively pressurised gas; and optionally, a negative spring device arranged to transmit a force to the load-bearing surface. Preferably, the air spring contains a mass of adsorptive material to lower the (dynamic) spring rate.

Alternatively, or additionally, the air spring contains a mass of heat sink material (such as open-cell foam (i.e. a material having a cellular structure) and/or a block of gas permeable resilient material), and/or a mass of absorptive material. Such materials may be present in any one or more of the main chamber; the optional spacing element having a variable volume; and the optional negative spring device.

Preferably, the adsorptive material is activated carbon.

In one embodiment, the main chamber contains a mass of adsorptive material and/or open cell foam to lower the spring rate.

In one embodiment, the negative spring device comprises a chamber and a positively pressured gas within the chamber. Preferably, the chamber contains a mass of adsorptive material and/or open cell foam. In one embodiment, the negative spring device is a removable unit from the air spring.

In one embodiment, the air spring further comprises a spacing element having a variable volume and being in fluid communication with the main chamber.

In one aspect, the present invention provides a suspension fork comprising an air spring as disclosed herein.

In one aspect, the present invention provides a bicycle or motorbike comprising an air spring as disclosed herein. Preferably, the bicycle is a mountain bike.

In one aspect, the present invention provides a bicycle or motorbike comprising a suspension fork as disclosed herein. Preferably, the bicycle is a mountain bike.

In one aspect, the present invention provides a spacing element for an air spring. The spacing element preferably has a variable volume as described herein and comprises a mass of adsorbent material. Alternatively, or additionally, the air spring contains a mass of heat sink material (such as open-cell foam (i.e. a material having a cellular structure) and/or a block of gas permeable resilient material), and/or a mass of absorptive material.

### BRIEF DESCRIPTION OF DRAWINGS

Embodiments will now be described, by way of example only and with reference to the accompanying drawings having like-reference numerals, in which:

FIG. 1 shows a graph of stiffness against frequency for a normal air spring and an air spring according to the current invention when loaded dynamically;

FIG. 2 shows a diagram of three air spring cylinders in differing configurations;

FIG. 3 shows two graphs of stiffness against displacement. The upper graph showing static displacement and the lower graph showing dynamic displacement;

FIG. 4 shows three diagrams of an air spring cylinder according to the current invention with the piston in three different positions;

FIG. 5 shows a close up view of two possible embodiments of the air spring cylinder of FIG. 4;

FIG. 6 shows a static pressure displacement graph of the air spring cylinder of FIG. 5 in comparison with the cylinders of FIG. 2;

FIG. 7 shows a dynamic pressure displacement graph of the air spring cylinder of FIG. 5 in comparison with the cylinders of FIG. 2;

FIG. 8 shows a further close up view of a further embodiment of the air spring cylinder of FIG. 5; and

FIG. 9 shows an air spring cylinder according to the current invention with the addition of a negative spring.

### DESCRIPTION OF THE INVENTION

The use of an adsorptive material in an air spring to spring rate has been described in several patents, including US patent application 2018/045264(A). However, the prior art does not describe the distinctive benefit that adsorptive materials have to dynamic spring rate.

An air spring can be thought of as both an actuator and a spring, simultaneously. As an actuator, the force delivered by an air spring containing only pressurised gas contained within parallel walls increases in direct proportion to pressure, which in turn increases in direct inverse proportion to the proportion of volume that has been compressed. For example, pressure and force will double in a spring when its volume is halved. This represents its static spring rate.

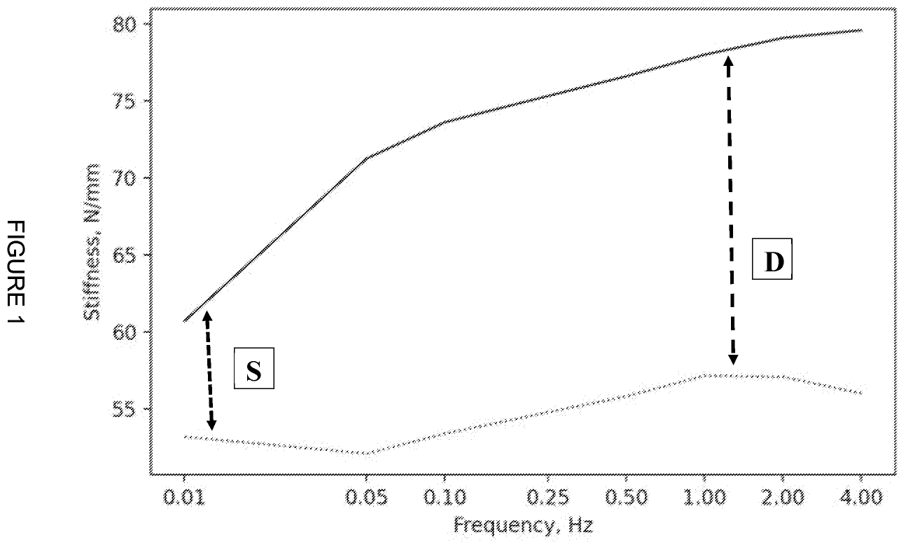

The situation is changed when an adsorptive material is disposed inside the cavity. The pressure no longer doubles in the example above but will increase by a lesser amount according to the type of adsorptive material used, and the proportion of the volume it occupies, as air molecules become adsorbed into the micropores of the material by Van der Waals forces. If the cavity is one third occupied by a well activated carbon (see FIG. 1), then the static pressure increase might be reduced by around 15% (the gap between the two curves at 0.01 Hz, indicated by the dashed line “S”).

However, as an air spring, the device's stiffness- or dynamic spring rate-increases significantly under dynamic excitation. If the compression cycle is quicker than the heating of the gas caused by compression has time to dissipate, the device will become significantly stiffer-in the case of air, by around 40%. The device transitions from an isothermal (static) state to an adiabatic (dynamic) state at a particular frequency, governed by a range of factors including the geometry and size of the device and the thermal conductivity of the walls of the vessel. However, when activated carbon or any other highly porous adsorbent material is present, the stiffness of the system does not rise by anywhere near the same extent, in part because the material itself acts as a heat sink. In the scenario above as shown in FIG. 1, while the static stiffness of an adsorbent-occupied device might be 15% lower, the dynamic stiffness was 40% lower than if the device contained only air or nitrogen (the gap between the curves at 2 Hz, indicated by the dashed line “D”).

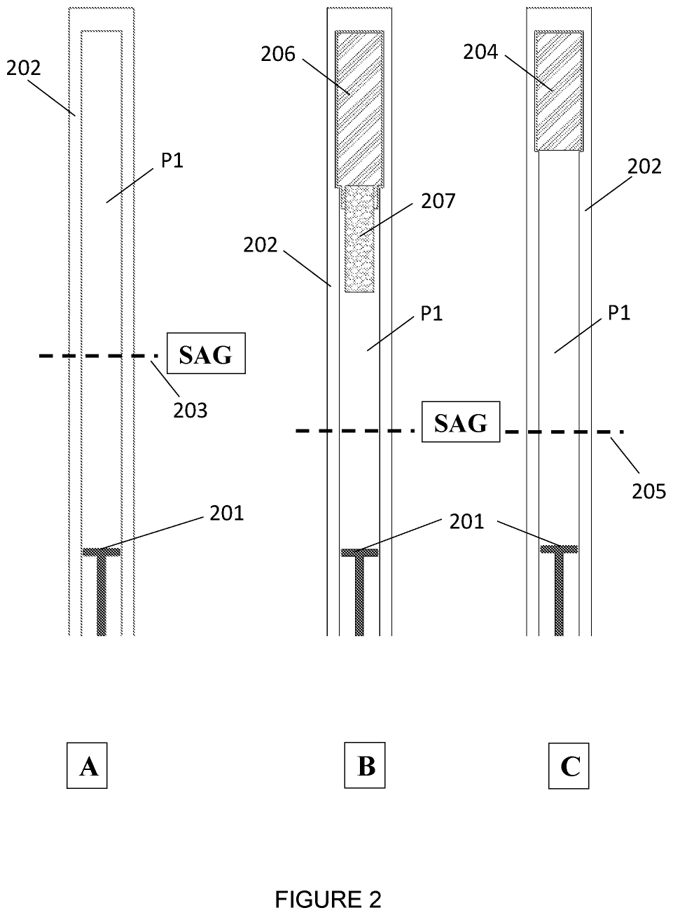

This disparity means that in a scenario where a blanked-off volume or volume spacers are used to achieve a desired sag point or equilibrium under load in a conventional gas-only gas spring, the use of an adsorptive material in the chamber shall necessitate a slightly larger blanking volume-perhaps around 15% larger in the example cited above-as shown in FIG. 2- to achieve the same sag point, because static pressure would otherwise build too slowly under the same loading before reaching equilibrium. But in this scenario the dynamic spring rate or stiffness would still be much lower than in the empty case, meaning that build-up in force during a rapid compressive event would be lower, and more linear.

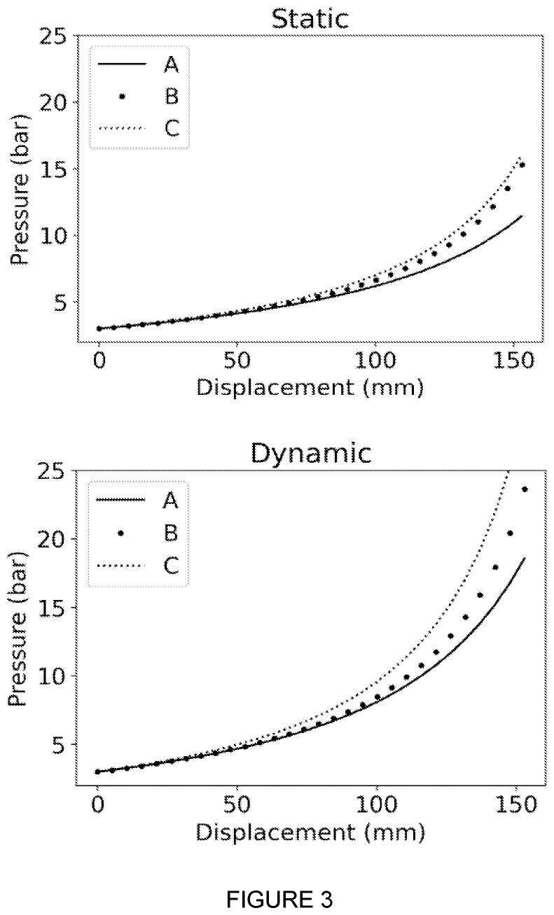

The quantity of adsorptive material may be tuned to ensure that the dynamic spring rate of the restricted volume was lower than a conventional air spring containing no blanked-off volume, but still retain the desired sag point for static pressure under load that the blanked-off volume was introduced to achieve. In effect, with the correct amount of adsorptive material used, the blanked-off volume may seem to disappear in terms of the dynamic spring rate- or stiffness—that is observed (FIG. 3).

The increased linearity of force build-up may be more attractive than the outright reduction in stiffness. A more progressive, or exponential increase in force means that the component passes through its suspension travel too quickly during an extreme compressive event before hitting a wall of force toward the end of travel. The objective of the suspension engineer may be to provide more “mid stroke support” earlier in travel and less extreme ramp-up on force toward the end of travel.

If an adsorptive material is disposed within the main chamber, a higher pressure setting may be used to achieve greater mid stroke support. But this, in conjunction with the increase in blanking volume size required to achieve a desired sag point, shall result in a high build-up in force toward the end of the piston's travel, albeit still not as high as when the adsorptive material is not present.

In an exemplary embodiment, the air spring includes an adjustable air chamber in addition to the positive and negative air springs, as described by Anthony Diaz in US patent application 2016/0001847 A1. The adjustable air chamber may generally occupy a space at the top of the stanchion (at the crown) and above the positive air spring in a bicycle or motorbike fork, while a quantity of adsorptive material may be disposed in fluid communication with the main air chamber.

However, in another embodiment an adsorptive material such as activated carbon may be disposed in either the main positive chamber, the main negative chamber, the adjustable pressure chamber or any combination of all three, to at first cause a virtual expansion of the main positive chamber to counteract the restrictive ramp-up effect of incorporating the secondary high pressure adjustable chamber.

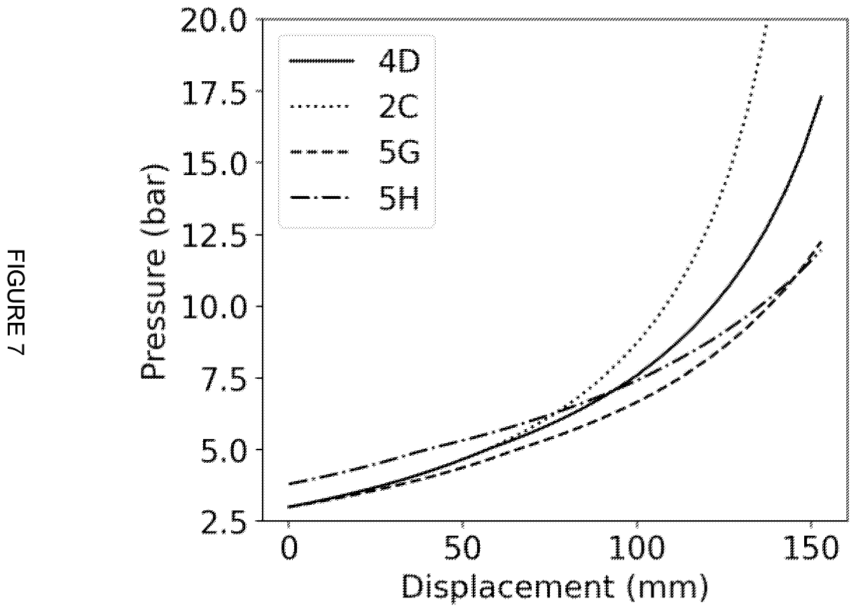

Thus, the use of a adsorptive material in conjunction with an adjustable high-pressure chamber allows normal spring rate and sag points to be used, or an enhanced volume negative chamber at slightly elevated pressure to be used to reduce stiffness at the start of travel, increase stiffness (or “support”) in the middle of travel, while enjoying the benefits of an adsorptive material where it is needed most—significantly reducing stiffness at the end of travel, allowing the suspension to absorb high-impact bumps and perturbations using the whole of its designed range (see FIG. 7).

In another aspect of the invention, a rear shock absorber may also include features that use an adsorptive material such as activated carbon to balance a decrease in initial volume of the air chamber of the positive air spring during the initial part of travel and may further include features for expanding the air chamber of positive air spring during a later part of travel, possibly augmented further by the disposal of activated carbon in the secondary chamber.

In an exemplary embodiment, a rear shock may include an adjustable air chamber similar to the fork, as above. In other exemplary embodiments, the rear shock may include an adjustable air chamber which may, for example, sit outside of the positive air spring, such as in an extension part or piggyback portion. The adjustable air chamber may operate generally similarly to the adjustable air chamber in the fork, as above, and may generally include a floating piston, with one end of the chamber on one side of the floating piston being in fluid communication with the positive air spring, such that pressure in the opposing end of the adjustable air chamber may load one side of the floating piston and the positive air spring may load the other side of the floating piston. A retaining feature may also be included to limit translation of the floating piston. In some embodiments, the adjustable air chamber may also include at least one spacer, similarly to the adjustable air chamber of the fork above.

In another aspect of the invention, other forms of air spring such as convoluted or rolling lobe air springs used in automotive applications such as front and rear air springs for cars, truck and bus air springs and springs used in air-suspended seating and cab mounts may use a similar configuration as cited in the invention. These primary springs do not feature negative springs or dynamic seals but may use activated carbon to reduce their spring rate generally. The use of a high-pressure adjustable cavity behind a floating piston disposed within a fixed portion of such an air spring will allow a lower starting pressure to be used for a given sag setting and may significantly reduce ramp up forces toward the end of travel. The use of activated carbon in either chamber will allow for the elimination of space reduction caused by the addition of the secondary high-pressure spring within the cavity while causing a significant reduction to ramp-up forces toward the end of travel, all allowing a greater effective range of operation to be used, particularly in all-terrain and off-road vehicles.

### DESCRIPTION OF THE DRAWINGS

The present invention will now be described with reference to the accompanying drawings in which:

FIG. 1 shows a graph of air spring stiffness, or spring rate, in an automotive air spring across a range of actuation frequencies, in newtons per millimetre. The solid line shows the rate in a standard air-filled spring at 6 bar, and the dotted line shows the rate in a spring with one third of its volume occupied by activated carbon. The graph shows that at very low frequencies, at 0.01 Hz, the two lines indicate the relative Static spring rates for the two conditions, with the gap between these shown by the marker line “S”. The gap between the Dynamic spring rates, at 2 Hz upwards, is shown by the marker line “D”.

FIG. 2 shows three air spring cylinders in three differing configurations. All three air spring cylinders shown include a primary piston 201 acting within a sealed primary air chamber 202 containing compressed gas (P1). The primary piston 201 includes a load bearing surface facing the sealed air chamber 202 and compressed gas P1, on which the compressed gas P1 acts and is arranged to move axially within the sealed air chamber 202. The sealed air chamber 202 is preferably a cylinder or includes a cylindrical portion in which the piston moves axially. The piston 201 is connected to a load by a connecting means for transmitting a force between the load and the load bearing face of the piston and thus to the compressed gas P1. The cylinder of case A comprises only the primary piston 201 acting within the sealed primary air chamber 202 also known as a main chamber 202. The cylinder of case C further includes a secondary fixed volume 204. The cylinder of case B further includes a secondary fixed volume 206 of greater volume that the secondary fixed volume 204 of cylinder C and a quantity of adsorptive material 207.

In FIG. 2 all three configurations of air spring cylinder have the same load applied to the piston 201, and thus the same static pressure is achieved at all SAG points 203, 205. A sag point 203 is indicated, for case A showing the position that the piston will reach when it is loaded with the weight of a rider etc. In case C, a secondary fixed volume 204 as a spacing element has been disposed within the chamber to ensure that a lower desired sag point 205 is achieved when the piston is loaded 205, as the lower volume of compressed gas has a greater spring rate when compared to case A. In case B, a larger fixed volume 206 as a spacing element is disposed within the chamber, attached to a quantity of adsorptive material 207 providing a lower volume of compressed gas compared to case B. However, due to the effect of the adsorptive material the piston of case B reaches the same sag point under the same load as seen in case C.

FIG. 3 shows two graphs of air spring pressure vs displacement in the three cases shown in FIG. 2. The upper graph shows static pressure vs displacement and the lower graph shows dynamic pressure vs displacement. Case A is shown in the solid line, case B in heavy dotted lines and case C in fine dotted lines.

The upper graph shows that the rise in static stiffness in cases B and C is very similar over the first 120 mm of travel, and so will result in the same Sag point 205 under the same loading. Case A static stiffness rises more slowly with displacement, resulting in a higher SAG point 203 for the cylinder of case A compared to cases B and C. However the relative dynamic stiffness of the three air spring cylinders is different. The dynamic stiffness of case C is highest, meaning that the spring has been made stiffer by the presence of the secondary volume. But surprisingly, given the lower volume of compressed gas in case B, cases A and B are very similar over the first 120 mm. Therefore, the presence of the adsorptive material 207 has eliminated the stiffening effect of the secondary volume 206, despite the secondary volume 206 of case B being larger than the secondary volume 204 in case C.

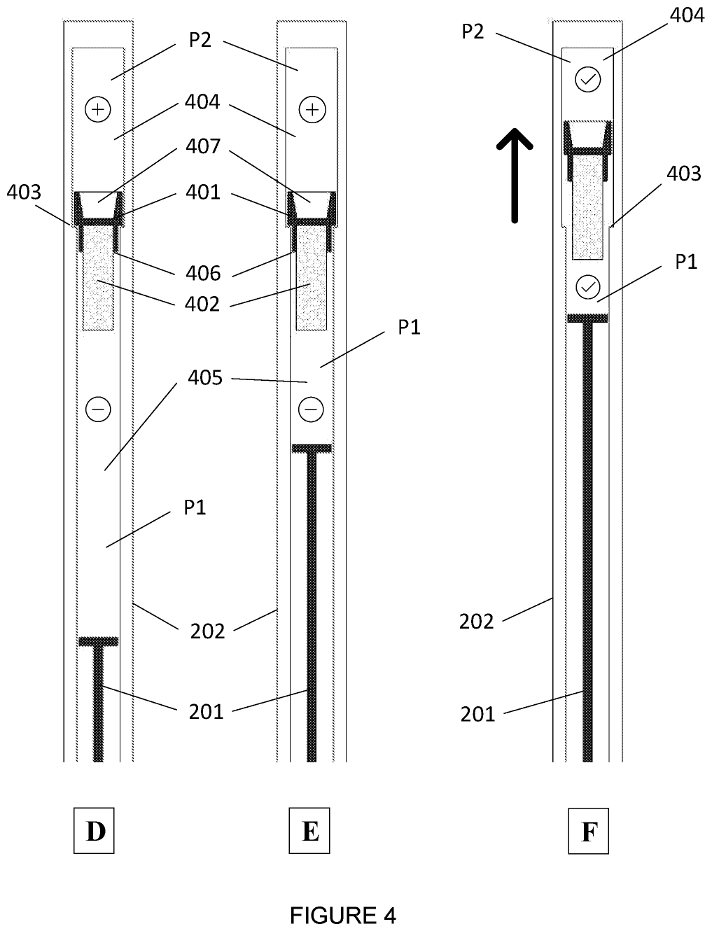

FIG. 4 shows a diagram of a single air spring cylinder in three positions. The air spring cylinder of FIG. 4 has a configuration similar to FIG. 2 case B but with the static volume 206 replaced by a spacing element having a variable volume, provided by a secondary chamber 404. In cases D and E, a piston 201 acts within a sealed primary chamber 202 as described in FIG. 2. The air spring cylinders of FIG. 4 further include a floating piston 401 as a moveable member 401 with a quantity of adsorptive material 402 attached to it. Said floating piston 401 moves axially within the primary chamber 202 and sits on a ledge 403 or constriction 403 within the sealed chamber 202 which restricts the travel of the floating piston 401 in one direction. The floating piston 401 provides a sealed secondary cavity 404, within the sealed primary chamber 202, on the opposite side of the floating piston 401 to a primary cavity 405. The primary cavity 405 comprises the volume in the sealed primary chamber 202 not occupied by the spacing element and is charged with a compressed gas to a pressure P1 as for the cylinders of FIG. 2. The secondary cavity 404 above the floating piston 401 is charged with a compressed gas to a higher pressure P2 than the primary cavity 405 beneath the floating piston 401. The floating piston 401 includes a primary face 406 facing the primary cavity 405 and a secondary face 407 facing the secondary cavity 404. The primary face 406 and the secondary face 407 being the bottom face and the top face respectively as displayed in FIG. 4. It will be understood that the variable volume chamber 404 could be provided by an alternative structure such as a balloon of inelastic material.

When pressure P1<P2 the force exerted on the secondary face 407 of the floating piston 401 by the compressed gas P2 exceeds the force exerted on the primary face 406 of the floating piston 401 which preloads the floating piston 401 against the ledge 403. In this state as shown in cases D and E of FIG. 4 the combined volume of the floating piston 401 and secondary cavity 404 to act like the fixed secondary volume 204, 206 in FIG. 2 cases B and C. In Case E, the primary piston has moved up the primary chamber which will increase the pressure of compressed gas P1, but the pressure P2 in the secondary cavity 404 still exceeds the pressure in the primary cavity 405. Therefore, the force on the secondary face 407 is still greater than that on the primary face 406 and the floating piston 401 remains against the ledge 403. In Case F, the pressure P1 in the primary cavity 405 has matched the pressure P2 secondary cavity 404 and the corresponding force on the primary face 406 has matched that of the secondary face 407. With the floating piston able to move freely upwards, as the piston 201 continues to compress the gas within sealed chamber 202, the floating piston 401 moves from the ledge 403 as the gas in the secondary cavity 404 is compressed and the force on the primary face 406 and the secondary face 407 are maintained in equilibrium. Thus, the primary and secondary volumes have unified, with the floating piston no longer causing a build-up in pressure beneath it, relative to the volume above it. Therefore, the spacing element is compressed at a predetermined pressure P1 governed by the pressure of compressed gas P2 at which the secondary cavity 404 is charged.

It will be understood that the terms above, below and beneath used above relate to the orientation of the air spring cylinders as displayed in FIG. 4 and that the relationship of the components in the system would be maintained if the air spring is in an alternative orientation.

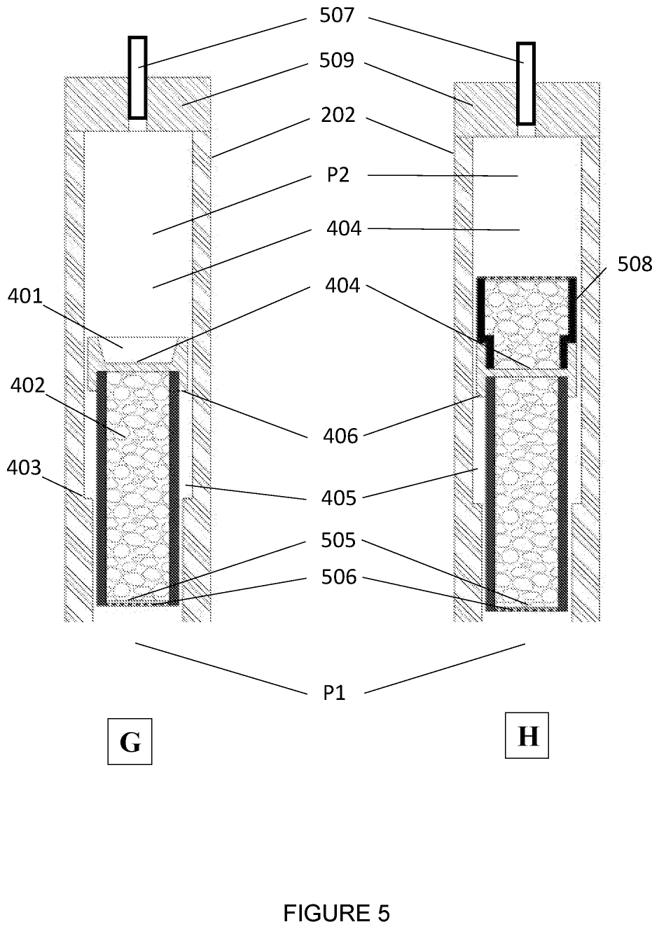

FIG. 5 shows a diagram of the air spring cylinder configuration of FIG. 4 in more detail. Case H includes an option to place a quantity of adsorptive material within the variable volume chamber of the secondary cavity 404. In case G, a floating piston 401 sits within a cylinder, with its downward motion limited by a ledge, protuberance, ridge or similar 403. Mounted to the underside of the piston 401 is a first container 503 which has disposed within it a quantity of heat sink or adsorbent material 402, such as activated carbon 402. The material 402 may be in loose granular form, an agglomerated or sintered monolith form or be an open cell matrix or foam, which may be impregnated with an adsorbent material. The material 402 may be kept behind a fine gauze 505 or porous filter material 505, which itself is held behind a protective grill 506 or perforated end-cap 506. The gas in the secondary cavity 404 above the floating piston P2 is charged or pressurised through a valve 507 in the cap 509 of the cylinder 202, to attain a higher pressure P2 than that of the pressurised gas P1 in the primary cavity 405 below the floating piston 401. The primary cavity 405 must be charged separately lower down the sealed chamber 202. In case H, the configuration shown is as in case G with the addition of a second container 508 of adsorbent or heat-sink material is attached to the secondary side 407 of the floating piston 401 facing the secondary cavity 404.

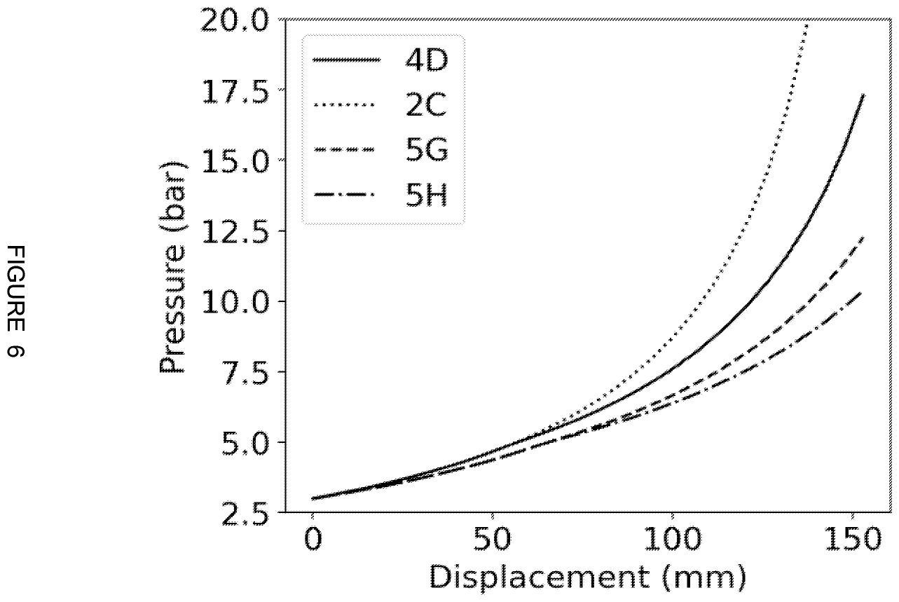

FIG. 6 shows a graph of dynamic pressure against displacement resulting from the configurations illustrated in FIGS. 2, 4 and 5. The fine dotted line shows the rise in pressure in the primary chamber if the secondary volume was fixed, as in FIG. 2C. The solid line shows the rise in pressure with a variable-volume secondary chamber as shown in FIG. 4, but without any adsorbent material involved. Both lines are identical up to a point in the compression stroke (at 60 mm) on the graph when the pressure in the primary chamber matches that in the secondary chamber, where a floating piston is in play. Beyond this point, the variable-volume configuration shows a reduced rise in pressure. The heavy dashed line shows how pressure progresses in the configuration seen in FIG. 5G, with an activated carbon container facing into the primary chamber only, and the heavy chain-dashed line shows the effect of configuration FIG. 5H, with activated carbon containers facing both the primary and secondary cavities.

FIG. 7 shows the same group of configurations described in FIG. 6, but with pressure in the primary chamber of the double-carbon configuration (5H, in heavy chain-dashed line) set at higher level. This results in a pressure curve which exceeds the 1C curve in the range up to 60 mm, but still dips below all configurations by the end of compression. This higher pressure at the start of travel means that a larger negative chamber could be used in a spring that uses a positive and negative spring, above and below the primary piston. The larger negative chamber will case a reduction in stiffness early in the stroke (up to 30 mm). Hence, the dual-carbon variable volume configuration enables a spring that is softer over the initial excursion, firmer in the middle of excursion and softer at the end of excursion than is possible with a variable-volume chamber that doesn't employ an adsorbent material.

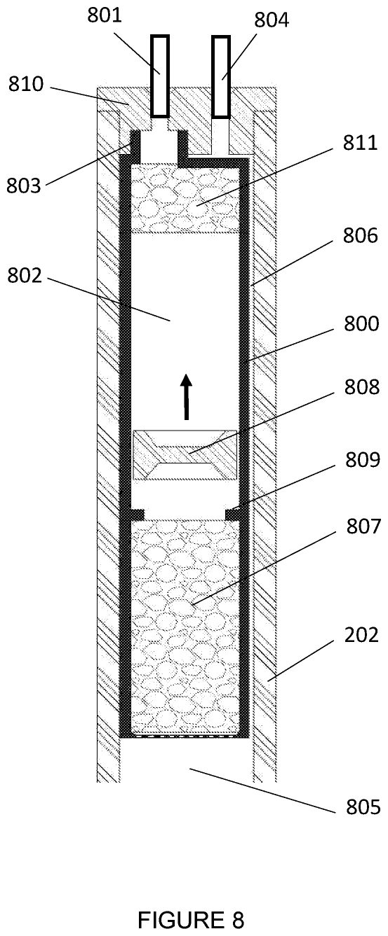

FIG. 8 shows a further configuration of the invention in which the spacing element again includes a variable volume chamber 802 but in the form of a wholly-removeable cartridge 800 containing a floating piston 808 beneath a separately chargeable pressure chamber 802. The variable volume chamber 802 is a secondary cavity 404 and includes at least a cylindrical portion in which the floating piston 808 moves to vary the volume of the variable volume chamber 802. The floating piston 808 includes a primary face 812 facing the primary cavity 405 and a secondary face 813 facing the variable volume chamber 802. The variable volume chamber 802 is charged with a compressed gas P2 in the same fashion as the secondary cavity 404 of the embodiment of FIG. 4. The primary face 812 in fluid communication with the compressed gas P1 in the primary cavity 405 and the secondary face 813 in fluid communication with the variable volume chamber 802. The air cap 810 at the top of the sealed primary air cylinder 202 features two charge valves 801, 804. The first 801 charges the variable volume cavity 802 in the removable cartridge 800 which is attached to the underside of the air cap 810 via a screw-in thread 803 or similar. The second valve 804 charges the primary chamber volume 805 via a groove or channel 806 that is left open on one side of the cartridge. A quantity of adsorptive material 807 is disposed within the cartridge 800 beneath the floating piston 808 in fluid communication with the primary chamber 805. A ridge or ledge 809 limits the travel of the floating piston 808 and protects the adsorptive material 807 from percussive impact from the floating piston 808. A second quantity of adsorptive material 811 may be disposed within the variable volume cavity 802. Alternatively, both quantities of adsorptive material 807, 811 may be mounted to the floating piston 808, in a similar fashion to that shown in FIG. 5H.

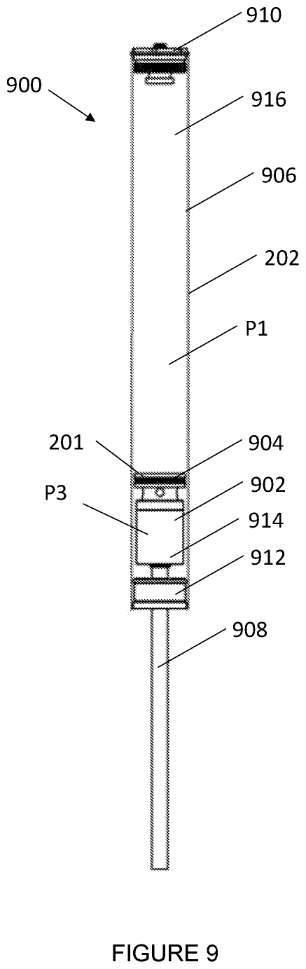

FIG. 9 shows a further embodiment in which an air spring 900 comprises a negative spring device 902 which is arranged to transmit a force to a piston 904. The negative spring device comprises a chamber 914 which contains a positively pressurised gas P3 in use. The air spring is formed of a cylindrical body 906 and comprises a piston 904 and a rod 908 which moves into and out of the body 906 in an axial manner. The body comprises an end section 910 at end opposite the rod 908, and an oil bath/seal arrangement 912 at an end adjacent the rod. The rod 908 enters the body 906 via the oil/bath seal arrangement 912.

In between the end cap 910 and the piston 904 there is a sealed main chamber 202, 916 in which the piston 904 is arranged to move in an axial direction along the length of the cylindrical body 906. The main chamber 916 contains a positively pressurised gas P1 in use.

In between the oil bath seal arrangement 912 and the piston 904 there is a sealed chamber 914 for the negative spring device. The chamber 914 is separated from the main chamber 916 by the piston 904. The chamber 914 contains a positively pressurised gas P3 in use and is arranged to transmit a force to the piston 904 in use. The negative spring device 902 includes a negative spring piston running axially within and sealing the chamber 914. Thus chamber 914 also acts as a second air spring. Preferably the chamber 914 is cylindrical. The chamber 914 is connected to and moves with the piston 201 of the main chamber 202. The negative spring piston includes an engagement means that is engaged by the oil bath seal arrangement 912 when the air spring provided by the main chamber is nearing full extension. The engagement means includes an engaging portion that extends axially from the chamber 914 towards the oil bath seal arrangement 912 such that the engaging portion engages said seal arrangement 912 causing the negative piston to engage the seal arrangement 912 before the primary piston 201 is at full extension resulting in the negative piston moving within the sealed chamber 914 and compressing the compressed gas P3. It will be understood that the positions of the chamber 914 and the negative piston may be reversed and the same effect be achieved.

In accordance with the embodiment of FIG. 2, the air spring 900 may comprise a spacing element having a fixed volume that occupies a volume of the main chamber as described in the embodiment of FIG. 2. Alternatively, or additionally, the air spring 900 may comprise spacing element having a variable volume chamber as described in the embodiment of FIGS. 4, 5 and 8.

In the embodiment of FIG. 9, the negative air spring device 902 is provided with a mass of adsorbent material 918, preferably activated carbon, to lower the spring rate. Thus, providing an adsorbent material in the negative chamber will provide more accommodation for gas and thereby increasing the effective volume of the negative chamber to reduce stiffness at the start of suspension travel.

The reader will appreciate that the adsorptive material and/or open cell foam as disclosed herein may be present in any one or more of the main chamber; the spacing element having a variable volume; and the negative spring device.

It will be understood that all pistons described above include a sealing means for sealing the piston to the walls of the chamber within which they move. Said sealing means may include a seal of any kind for example, a rubber O-ring or a piston ring.

Any system feature as described herein may also be provided as a method feature, and vice versa. As used herein, means plus function features may be expressed alternatively in terms of their corresponding structure.

Any feature in one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently

1. An air spring for supporting a load, the air spring comprising:
a main chamber containing a positively pressurised gas (P1) in use;
a spacing element having a variable volume and being within the main chamber
a load-bearing surface arranged to transmit a force from a load in use to the positively pressurised gas (P1);
optionally, a negative spring device arranged to transmit a force to the load-bearing surface; and
wherein the air spring contains a mass of adsorptive material and/or open cell foam for lowering the spring rate and the spacing element having a variable volume is a removable unit from the air spring.

2. The air spring according to claim 1, in which the variable volume of the spacing element is compressed at a predetermined pressure in use by the positively pressurised gas (P1) in the main chamber.

3. The air spring according to claim 1, in which the spacing element comprises a movable member wherein the variable volume is separated from the main chamber by the moveable member.

4. The air spring according to claim 1, in which the main chamber contains a mass of adsorptive material and/or open cell foam.

5. The air spring according to claim 1, in which the variable volume contains a mass of adsorptive material and/or open cell foam.

6. The air spring according to claim 1, in which the main chamber and the variable volume contain a mass of adsorptive material and/or open cell foam.

7. (canceled)

8. The air spring according to claim 1, in which the negative spring device comprises a chamber and a positively pressured gas (P3) within the chamber.

9. The air spring according to claim 7, in which the chamber contains a mass of adsorptive material and/or open cell foam.

10. The air spring according to claim 1, in which the negative spring device is a removable unit from the air spring.

11. The air spring according to claim 1, in which the adsorptive material is activated carbon.

12. The air spring according to claim 1, further comprising a spacing element having a fixed volume that occupies a volume of the main chamber.

13. The air spring according to claim 3, wherein the variable volume of the movable member comprises a sealed secondary cavity, within the main chamber, containing in use a pressurised gas P2.

14. (canceled)

15. A bicycle or motorbike comprising the air spring according to claim 1.

16. An air spring for supporting a load, the air spring comprising:
a main chamber containing a positively pressurised gas (P1) in use;
a spacing element having a fixed volume that occupies a volume of the main chamber;
a load-bearing surface arranged to transmit a force from a load in use to the positively pressurised gas;
optionally, a negative spring device arranged to transmit a force to the load-bearing surface; and
wherein the air spring contains a mass of adsorptive material and/or open cell foam to lower the spring rate and the spacing element having a fixed volume is a removable unit from the air spring.

17. The air spring according to claim 16, in which the main chamber contains a mass of adsorptive material and/or open cell foam.

18. The air spring according to claim 16, in which the negative spring device comprises a chamber and a positively pressured gas within the chamber.

19. The air spring according to claim 18, in which the chamber contains a mass of adsorptive material and/or open cell foam.

20. (canceled)

21. The air spring according to claim 16, in which the adsorptive material is activated carbon.

22. The air spring according to claim 1, further comprising a spacing element having a variable volume and being in fluid communication with the main chamber.

23. (canceled)

24. (canceled)

25. A bicycle or motorbike or suspension fork comprising an air spring according to claim 1.

26. The air spring according to claim 16, in which the negative spring device is a removable unit from the air spring.
